(19) United States
(12) Patent Application Publication
(10) Pub. No.: US 2018/0191942 A1
(43) Pub. Date: Jul. 5, 2018

(54) SYSTEMS, METHODS AND MACHINE-READABLE MEDIUMS FOR QUEUE MANAGEMENT OF A CAMERA DEVICE

(71) Applicant: Michael Cantwell, San Clemente, CA (US)

(72) Inventor: Michael Cantwell, San Clemente, CA (US)

(21) Appl. No.: 15/423,334

(22) Filed: Feb. 2, 2017

Related U.S. Application Data
(60) Provisional application No. 62/291,414, filed on Feb. 4, 2016.

(51) Int. Cl. H04N 5/232

(52) U.S. Cl. CPC H04N 5/23206; G06K 7/1417

(57) ABSTRACT

A control access system is disclosed. The control access system comprises a network camera having an IP address and capable of remote access via a network and a queue management system coupled to the network camera, and programmed for real-time management of control access requests from one or more remote mobile devices. The real-time management comprises queuing the control access requests on a first-in first-out basis, the control access requests allow access to and control of the network camera.

### CROSS-REFERENCE TO RELATED APPLICATIONS

The application claims benefit under 35 U.S.C. § 119(e) from U.S. Provisional Application No. 62/291,414, filed on Feb. 4, 2016. The above application is hereby incorporated by reference in its entirety and is to be considered a part of this specification.

### BRIEF DESCRIPTION OF THE DRAWINGS

These and other features and advantages of the present embodiments will become more apparent upon reading the following detailed description and with reference to the accompanying drawings of the embodiments, in which:

FIG. 1 illustrates a block diagram outlining examples for accessing a control access system, according to a first embodiment of the present disclosure.

FIG. 2 illustrates a block diagram outlining the operation of the control access system, according to a first embodiment of the present disclosure.

FIG. 3 illustrates a block diagram of the control access system, according to a first embodiment of the present disclosure.

FIG. 4 illustrates a block diagrams of the control access system and method of operation, according to a second embodiment of the present disclosure.

FIG. 5 illustrates a block diagrams of the control access system and method of operation, according to a third embodiment of the present disclosure.

### DETAILED DESCRIPTION

The following detailed description includes representative examples utilizing numerous features and teachings, both separately and in combination, and describes numerous embodiments that relate to systems, methods, and machine-readable mediums for queuing a plurality of users to remotely access and control a camera device. This detailed description is merely intended to teach a person of skill in the art further details for practicing one or more embodiments of the present disclosure and is not intended to limit the scope of the claims. Therefore, combinations of features disclosed in the following detailed description and incorporated documents may not be necessary to practice the teachings in the broadest sense, and are instead taught merely to describe particularly representative examples of the present teachings.

Some portions of the detailed description that follow are presented in terms of algorithms and sequences of operations, which are performed within a computer memory. These algorithmic descriptions and representations are the means used by those skilled in the data processing arts to most effectively convey the substance of their work to others skilled in the art. An algorithm or sequence of operations is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated.

It should be borne in mind, however, that the algorithms and/or sequence of operations are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic device, that manipulates and transforms data represented as physical (electronic) quantities within the computer system's registers and memories into other data similarly represented as physical quantities within the electronic device's memory or registers or other such information storage, transmission or display devices.

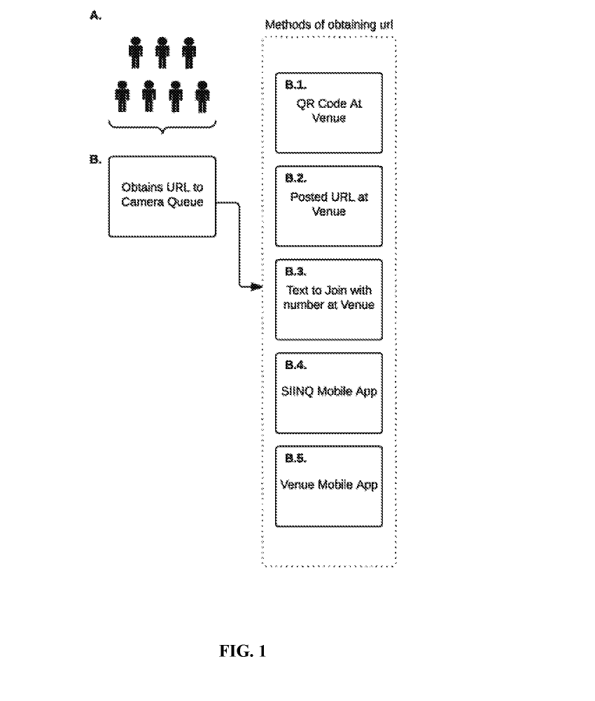

FIG. 1 illustrates a block diagram outlining examples for accessing a control access system, according to an embodiment of the present disclosure. As can be appreciated, the control access system may be used any venue or location to allow one or more users to access and control a camera remotely from a mobile device, transmit instructions to take a picture or video from the camera and facilitates photo/video saving and sharing at one or more social media platforms.

In one embodiment, a user may enter a venue or location where a camera is installed. As shown in the exemplary figure above, a user may gain access to the camera device through a number of on-site or application based means. For example:
A QR code located at the camera application may redirect the user to the camera's unique URL (B.1.).
A URL may be publicly displayed at the venue for the user to enter into their web-browser (B.2.).
A phone number or short code may be publicly displayed at the venue. User texts the phone number a message and receives the URL to the camera device in return (B.3.).
The user may also select the location from a mobile application and be granted access to the service (B.4.).
A mobile application may be provided by the venue could provide specialized links to the application or web service (B.5.).
A NFC (near field communication) tag displayed publicly. User may swipe the mobile device against the NFC tag to connect to a URL or mobile application.

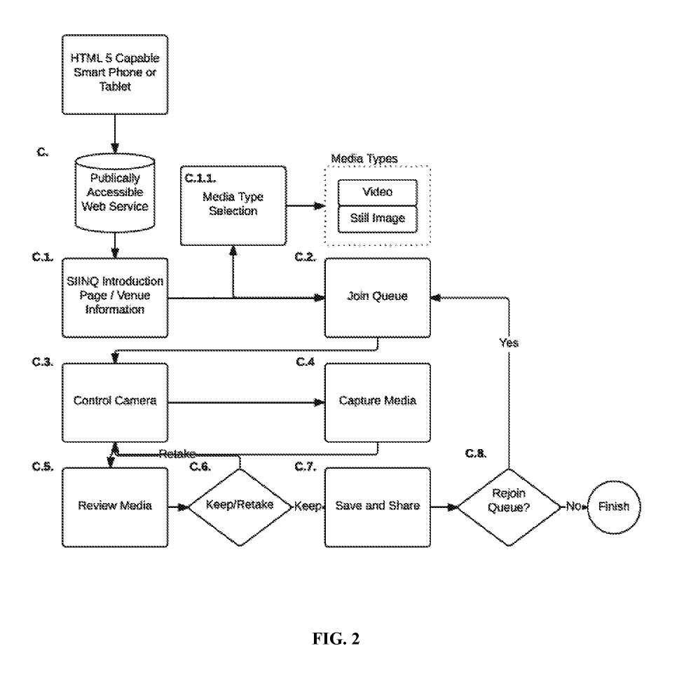

FIG. 2 illustrates a block diagram outlining the operation of the control access system, according to an embodiment of the present disclosure. In one embodiment, a publicly accessible web service may be used to allow the user to wait in line to use a fixed-point or mobile camera, may provide the ability to control the camera remotely (pan, zoom, tilt) and may allow the user to save or share the result. As can be appreciated, a page explaining the control access system may be prompted to a user on his/her mobile device, provides venue information, and allows the user to join a queue of users that have sent request code via the software application to access and control a remote camera (C.1.). Optionally, the user may be prompted to choose the type of media they wish to capture during their session. They may choose between a short video or still images (C.1.1). The user may then join the queue which, in one embodiment, operates on first-come-first-serve basis (C.2.). As can be appreciated, an estimated wait time and advertisements are displayed to the user. When cameras are installed at a venue (i.e. stadiums), the user may be directed to enter their section and seat number to become discoverable by the camera. The camera may then rotate through the queue to find the user's location in the stadium.

Once the user gets his/her turn in the queue, the user may be permitted to control the camera using, for example, gestures (C.3.). They may pinch and split to zoom in and out and move their finger on the image to pan and tilt. When the user and camera are correctly positioned, the user may begin to capture the selected media (photo/video) (C.4.). After the selected media is captured it is presented to the user to review (C.5). In one embodiment, if time permits, the user may choose to retake or keep the captured media (C.6.). Retaking may a) place them a back into control of the camera if time remains or b) place them back in the queue if they have exceeded their time limit. The user may then be provided with a number of options to save or share the media (C.7.), rejoin the Queue (C.8.), and/or finish the process.

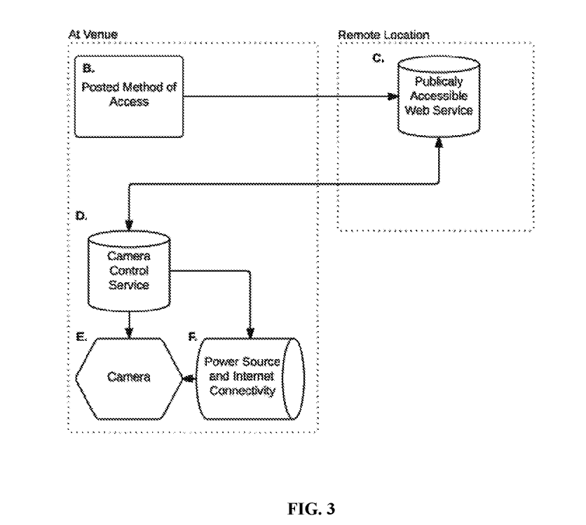

FIG. 3 illustrates a block diagram of the control access system, according to an embodiment of the present disclosure. The control access system may include a web service accessible via web server (C), which is in communication with camera control device (D). As can be appreciated, this provides security and API to access the electrically coupled camera device (E). In one embodiment, the camera device (E) may be an AXIS™ web compatible pan-zoom-tile camera, with power and connectivity made available at the venue/location (F).

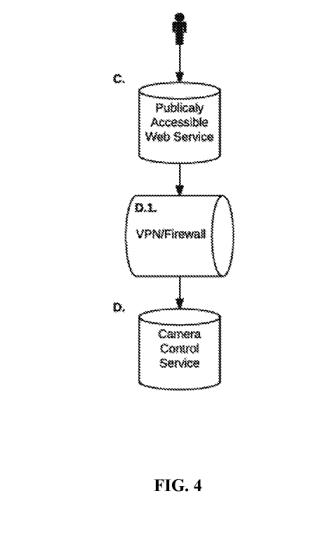

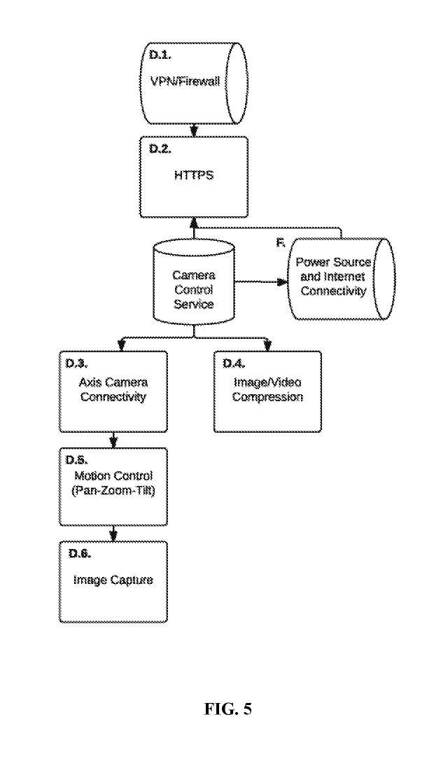

FIGS. 4 and 5 illustrate block diagrams of alternative embodiments of the control access system and method of operation, according to an embodiment of the present disclosure. As can be appreciated, VPN/firewall or other means known to persons skilled in the art may be used to further control and provide secured communication for the control access system.

While the data management systems, methods, and machine readable mediums have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

It should also be understood that a variety of changes may be made without departing from the essence of the invention. Such changes are also implicitly included in the description. They still fall within the scope of the invention. It should be understood that this disclosure is intended to yield a patent or patents covering numerous aspects of the invention both independently and as an overall system and in both method and apparatus modes.

Further, each of the various elements of the invention and claims may also be achieved in a variety of manners. This disclosure should be understood to encompass each such variation of an embodiment of any apparatus embodiment, a method, machine-readable medium or process embodiment, or even merely a variation of any element of these.

Particularly, it should be understood that as the disclosure relates to elements of the invention, the words for each element may be expressed by equivalent apparatus terms of method terms—even if only the function or result is the same. Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action. Similarly, each physical element disclosed should be understood to encompass a disclosure of the action which that physical element facilitates.

Any patents, publications, or other references mentioned in this application for patent are hereby incorporated by reference. In addition, as to each term used, it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans, incorporated herein by reference.

Finally, all references listed in the Information Disclosure Statement of other information statement filed with the application are hereby appended and hereby incorporated by reference; however, as to each of the above, to the extent that such information or statements incorporated by reference might be considered inconsistent with the patenting of this/these invention(s), such statements are expressly not to be considered as made by the applicant.

Further, all claim terms should be interpreted in their most expansive forms so as to afford the applicant the broadest coverage legally permissible. Although the embodiments have been described with reference to the drawings and specific examples, it will readily be appreciated by those skilled in the art that many modifications and adaptations of the processes and apparatuses described herein are possible without departure from the spirit and scope of the embodiments as claimed herein. Thus, it is to be clearly understood that this description is made only by way of example and not as a limitation on the scope of the embodiments as claimed below.

What is claimed is:

1. A control access system comprising:
a network camera having an IP address and capable of remote access via a network; and
a queue management system coupled to the network camera, and programmed for real-time management of control access requests from one or more remote mobile devices, the real-time management comprising queuing the control access requests on a first-in first-out basis, the control access requests allow access to and control of the network camera.

2. A non-transitory computer-readable medium that provides instructions, which when read by a computer having a processor and a database, cause the computer to perform operations comprising:
electronically receiving, over a network, control access request from a plurality of remote mobile devices, the control access request provides each remote mobile device an access to and control of a network camera;
queuing the control access requests on a first-in first-out basis; and
providing, to each of the plurality of remote mobile devices, access to the network camera, upon its turn in the queue.
